(19) United States
(12) Patent Application Publication
(10) Pub. No.: US 2006/0180731 A1
(43) Pub. Date: Aug. 17, 2006

(54) Foam liner for casting objects in poured walls

(76) Inventors: William Clare Scott, Elizabeth, CO (US); Mark Allison Scott, Superior, CO (US)

Correspondence Address: MERCHANT & GOULD PC, P.O. BOX 2903, MINNEAPOLIS, MN, 55402-0903, US

(21) Appl. No.: 11/050,007

(22) Filed: Feb. 2, 2005

(51) Int. Cl. B41B 11/54; B28B 7/22; B32B 37/16; B29C 65/02

(52) U.S. Cl. 249/15; 249/112; 156/439

(57) ABSTRACT

A liner holds objects in place within a form for a poured wall. The liner includes a backing sheet and a plurality of foam bed joints arranged in a substantially parallel fashion along a length dimension. A plurality of separate foam head joints are attached along a height dimension, wherein opposing ends of the foam head joints engage adjacent bed joints to define a plurality of regions on the backing sheet for receiving the objects to be cast in the poured wall. Each foam joint has a rounded cross section to form a curved grout line between the objects cast in the poured wall. The foam joints include an outer protective skin to prevent the poured wall material from bonding with the foam cells. A method of forming the liner includes aligning the separate foam bed joints and head joints in a grid and then pressing an adhesive-backed paper sheet against the foam joints.

### FIELD OF THE INVENTION

This invention relates generally to a liner for holding objects in place within a form for a poured wall so that the objects are embedded on the surface of the wall once the form and the liner are removed. More particularly, the present invention relates to a new and improved foam liner mounted to a backing material to form a continuous liner sheet that facilitates lining the form for the poured wall.

### BACKGROUND OF THE INVENTION

Modern building construction commonly includes simulated brick or stone walls to reduce the costs associated with fully laid up brick and stone walls. Such simulated walls are typically formed by embedding thin bricks or stones within a front surface of a poured concrete wall. For example, thin bricks or pavers are typically arranged on a front surface of a wall form prior to filling the form with a concrete slurry. Once the concrete slurry cures and the form is removed, the front face of the wall includes the brick pavers and, when done correctly, gives the impression of a true brick wall such as would be constructed by a mason.

Liners are typically used to both arrange and hold the brick pavers within the form for the poured wall. The liners include a number of recessed regions separated by joints for holding the brick pavers in a desired pattern. The joints between the recessed regions of the liner essentially form a reverse contour for the concrete slurry which fills in the spaces between the bricks and forms a “grout line” between the sides and ends of adjacent bricks. This grout line is similar to that which is present in conventional masonry construction.

A number of different types of brick liners have been utilized in the past. These include vacuum formed liners which are typically molded from a hard plastic material as well as foam liners that are molded or routed from a solid piece of foam to define the desired brick pattern. However, both of these types of liners suffer from problems that add to the cost and time required to form embedded brick walls with these prior art liners.

With respect to prior plastic liners, such liners are typically formed in relatively small sheets or “panels,” such as the VersaLiner™ panel manufactured by Innovative Brick Systems, Inc. of Broomfield, Colo. The size of these prior art brick liner panels is necessarily limited due to manufacturing and handling constraints (i.e., each panel holds approximately 40 bricks). Accordingly, a number of the liner panels must be aligned both vertically and horizontally within the form for the poured wall to provide an aesthetically acceptable simulated brick wall.

Each plastic liner panel includes outer borders shaped like the joint lines which extend between the bricks on the liner. These borders must be precisely aligned and overlapped with the borders on adjacent panels to provide a seamless continuation from one liner panel to the next and thereby maintain the illusion of the simulated brick wall. However, cutting and aligning a large number of hard plastic liner panels to fit within a form is time-consuming work. Furthermore, due to the inherent thickness of each plastic liner panel, the regions within the form where two or more panels overlap are necessarily raised above the remainder of the liners within the form so that the embedded bricks (or other objects) along these overlapping regions may appear to be misaligned or slightly recessed within the finished wall.

A further difficulty encountered with the prior plastic liner panels relates to the rigid nature of the panel material and particularly the curved joints between the recessed brick-receiving regions. These hard plastic joints define uniform brick-receiving regions in the liner panel which, in turn, require the use of brick pavers that are cut to very precise tolerances (so that the edges of the brick pavers fit snugly against the rounded plastic joints). Indeed, a close fit between the brick pavers and the plastic joints is necessary to prevent or at least reduce the amount of concrete material that leaks around the plastic liner joints and adheres to the face of the brick pavers. Unfortunately, such leakage is bound to occur since even custom-ground brick pavers will include some tolerance or margin of error in their outer dimensions. While brick pavers that are cut too small will leave a gap between the brick and at least one joint line that allows the poured-wall material to seep past the joint and contact the face of the brick paver, problems also arise when brick pavers are cut too large to fit cleanly within the brick-receiving region. Specifically, because the hard plastic joint lines are not malleable, the joints cannot adjust to accommodate oversized bricks. Thus, even a slightly oversized brick paver (i.e., ⅛ inch or more out of specification in either the length or the height dimension) will not be seated correctly within the liner, thereby allowing the poured-wall material to leak around to the front of the brick paver. Additionally, oversized bricks that do not fit properly within the liner will be misaligned (i.e., will not appear flush) with the other bricks, possibly causing unacceptable visual defects in the finished wall.

In order to ensure that the finished brick wall may be cleaned of any concrete material that collects on the front faces of the bricks, it is typically necessary to use specialized brick pavers that have had their faces coated with wax. Upon completion of the formed wall and removal of the plastic liner panels, a hot water (high pressure) spray is then applied to the face of the brick wall to remove the wax coating and any accumulated concrete material. In order to ensure that the wax can be removed with the hot water spray, the wax coating has a melting point of approximately 130 degrees Fahrenheit. However, in certain climates (such as Florida or Arizona), the temperatures in the mold may rise close to or even exceed the melting point of the wax, thus causing the wax coating to soften and wick into the brick or simply evaporate. A further drawback to the use of a wax coating relates to the added cost to have each brick coated with wax. Indeed, the combined extra cost of first grinding the brick pavers to the exacting dimensions required for use within the hard plastic liner, and then applying a wax coating to the faces of the brick pavers, nearly doubles the price of a standard brick paver.

Thus, prior art plastic brick liners suffer from a number of drawbacks mainly centering around the rigid nature of the plastic joints used to define the brick-receiving regions within the liner. Since it is not possible to form an airtight seal between the brick paver and the plastic joint lines (even when using ground bricks), concrete leakage onto the front faces of the brick pavers will be a constant problem necessitating the use of specialty wax-coated bricks to ease the process of cleaning the concrete off of the finished brick faces. Additionally, the plastic liner panels are not thermally stable, and thus the same high temperatures that can create difficulties with the wax coating may also cause the liner material itself to expand and create even larger gaps between the joints and the brick pavers. Lastly, workers using rigid plastic liner panels are not able to adjust the size or location of the vertical head joints to accommodate wall forms that are not sized to precisely fit the dimensions of the plastic liner panels (or to accommodate changes in the size of the panels due to temperature changes). For example, when a half-brick offset or “running bond” pattern is to be formed in a poured wall, it is desirable for the pattern to terminate precisely at the end of the wall so that only conventional full brick and half-brick pavers are required at each end of the wall. Unfortunately, due to measurement errors and the above-described thermal instability of the plastic liners, it is common that the one-half running bond brick pattern will not fit precisely within the wall form, thereby necessitating the grinding of custom-sized bricks (e.g, ⅜ and ⅞ bricks) to complete the pattern at one end of the wall. While a mason forming a fully laid-up brick wall can address such issues by adjusting (i.e., increasing or decreasing) the width of the vertical head joints near the end of the wall to ensure a proper fit, no such adjustments are possible with the fixed vertical head joints in the plastic liner panels.

While prior art foam liners address some of the above-described problems attributed to the hard plastic liner panels, such foam liners were not without their own problems. In particular, prior art foam liners used for casting objects in a poured wall were die cut or routed from a solid piece of foam to define the desired brick pattern. The foam grid was then placed on a paper backing with pressure sensitive tape as shown in U.S. Pat. No. 5,900,180 (“the '180 patent”). The '180 patent shares a common inventor with the currently-claimed invention, and the disclosure of the '180 patent is hereby incorporated by reference.

FIGS. 2-6 of the '180 patent illustrate a first problem with prior art foam liners—i.e., both the horizontal (“bed”) joints and the vertical (“head”) joints are formed with a square or rectangular cross section. Such square joints produce a flat rather than a curved grout line between the brick pavers in the finished wall, where the curved grout line is preferred since it produces a more natural appearance that more closely approximates a fully laid-up brick wall constructed by a mason.

A second problem associated with the foam liner shown in the '180 patent relates to the act of cutting or routing the foam material to form the desired grid pattern as shown in FIGS. 2 and 3 of the '180 patent. In particular, the routed or die-cut foam material leaves open foam cells around the edges of the joints as shown in FIGS. 5 and 6 of the '180 patent. These open cells tend to bond with the concrete material used to form the poured wall (as shown in FIG. 1 of the '180 patent). That is, the concrete material fills the exposed cells of the foam joint lines and prevent the joints from being stripped away from the finished wall. Thus, rather than stripping the paper backing sheet and foam joints cleanly away from the finished wall as shown in FIG. 2 of the '180 patent, portions of the foam joints remain embedded within the grout line between the brick pavers. Indeed, in the sole commercial implementation of the preferred embodiment shown in FIGS. 2-6 of the '180 patent, a significant amount of time was required to manually scrape the remnants of the foam joints from the grout lines of the finished wall.

Finally, while the malleable nature of the foam liner disclosed in the '180 patent helps to form a relatively snug seal with the brick pavers (thereby reducing the amount of leakage and accumulation of concrete on the faces of the bricks), the fully integrated nature of the foam grid (as shown in FIGS. 8 and 9 of the '180 patent) does not allow for large tolerances in the size of the brick pavers used to fill the foam liner. Specifically, because the foam grid is die cut from a single block of foam, the vertical head joints are formed integrally with the horizontal bed joints. This integral construction limits the relative movement of the adjoining head joints and bed joints so that it is difficult to squeeze a slightly oversized brick into one of the brick-receiving regions of the foam liner shown in '180 patent (i.e., the brick tends to bind at the corners where the head joint meets the bed joints and the foam material tends to push the brick back out of the pocket causing a noticeable misalignment in the finished wall).

Thus, a new brick liner is needed that addresses the shortcomings of both the prior art foam brick liners as well as the plastic liner panels. Specifically, a need exists for a brick liner which creates a more natural (i.e., curved) grout line in the finished wall but which does not require the use of specially prepared (i.e., ground and waxed) brick pavers. A need also exists for a brick liner that includes flexible head joints to allow for slight adjustments to the running bond pattern at one end of a form to avoid the need for custom-sized bricks at the end of a wall. Finally, a need exists for a foam liner that can be quickly and easily employed at the job site and then stripped completely from the finished wall.

It is with respect to these and other background considerations, limitations and problems, that the present invention has evolved.

### SUMMARY OF THE INVENTION

In accordance with this invention, the above problems are solved by a liner for casting objects in a face of a poured wall. The liner is positioned within a form for the poured wall and acts to hold the objects stationary (in a desired pattern) when a slurry of concrete or some similar material is poured into the form and covers the liner. The liner is formed from a backing sheet and a plurality of foam bed joints that extend in a substantially parallel fashion along a length dimension of the backing sheet. A plurality of separate foam head joints are also attached along a height dimension of the backing sheet, wherein opposing ends of the foam head joints engage adjacent bed joints to define a plurality of regions on the backing sheet for receiving the objects to be cast in the poured wall.

In one embodiment, each of the foam bed joints and foam head joints have a substantially semi-circular cross section with a flat base portion attached to the backing sheet and a rounded upper portion adapted to form a rounded grout line between the objects cast in the poured wall. The foam joints also include an outer protective skin to prevent the poured wall material from bonding with the foam cells. Two or more liner sheets may be combined to cover an extended wall surface by providing a finished edge and an open edge at opposite ends of the liner.

In a further embodiment of the present invention, the backing sheet is made from paper and may include either a plastic liner or a mesh sheet to increase the tear-resistance of the paper backing sheet. An adhesive layer may be applied to a top surface of the paper backing sheet to secure the foam joints in a desired running bond pattern. Furthermore, the individual head joints are separately detachable from the backing sheet to enable customized sizing for each of the object-receiving regions within the liner.

A further embodiment of the present invention relates to a method of forming a liner for embedding a plurality of objects in a face of a poured wall. The method includes adhering a plurality of extruded foam bed joints to a top surface of a backing sheet and also adhering a plurality of separate foam head joints to the top surface of the backing sheet between adjacent bed joints. The plurality of bed joints and separate head joints combine to form a plurality of regions for receiving the objects to be embedded within the poured wall. In one embodiment, the top surface of a backing sheet is coated with an adhesive layer and is then pressed into contact with a grid formed by the separate bed joints and head joints.

A more complete appreciation of the present invention and its scope may be obtained from the accompanying drawings, which are briefly summarized below, from the following detailed description of a presently preferred embodiment of the invention, and from the appended claims.

### BRIEF DESCRIPTION OF THE DRAWING

FIG. 1 is an isometric view of a wall mold showing a plurality of brick pavers positioned within an improved brick liner according to the present invention, where the brick pavers are embedded within a front face of a wall formed by filling the mold with pourable material such as concrete.

FIG. 2 is an enlarged isometric view of the brick liner shown in FIG. 1 illustrating two finished edges and two open edges of the liner sheet.

FIG. 3 is an enlarged section view taken substantially along the line 3-3 of FIG. 2 illustrating the cross sections of two adjacent foam bed joints.

FIG. 4 is an enlarged section view similar to FIG. 3 illustrating the placement of an oversized brick paver between the two adjacent foam bed joints.

FIG. 5 is an exploded view of the brick liner shown in FIG. 1 with portions cut away and with one of the foam head joints removed for clarity.

FIG. 6 is an enlarged section view taken substantially along the line 6-6 of FIG. 5 illustrating one end of a separately formed foam head joint overlapping a foam bed joint.

FIG. 7 is an isometric view of two overlapping brick liner panels in accordance with an embodiment of the present invention.

FIGS. 8A and 8B are isometric views of a conveyor belt and a drum roller showing a preferred method of forming the foam brick liner sheets of the present invention.

FIG. 9 is a top view of an alternative conveyor belt that may be used to form foam brick liner sheets having alternative running bond patterns.

### DETAILED DESCRIPTION OF THE PREFERRED EMBODIMENTS

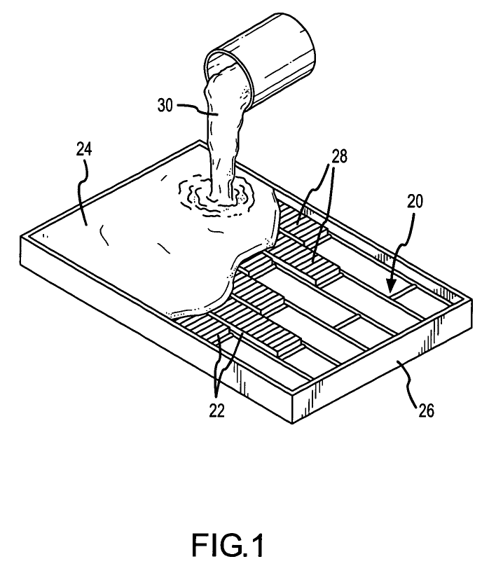

FIG. 1 illustrates a preferred embodiment of the present invention comprising a liner sheet 20 designed to accommodate a plurality of thin bricks 22 known as brick pavers. Brick pavers 22 have the same length and width dimensions of conventional bricks, but typically have a thickness of less than one inch. The liner sheet 20 of the present invention is used to first arrange the brick pavers 22 in a desired pattern and then embed the brick pavers 22 within a surface of a poured wall 24, as shown in FIG. 1. In particular, the liner sheet 20 is preferably positioned on an interior surface of a form 26 for the poured wall 24, and the brick pavers 22 are then inserted face down within the liner 20 so that a rear surface 28 of each paver 22 is exposed as shown in FIG. 1. Next, the cement wall material 30 is poured into the form 26 so that the cement material completely covers the rear surfaces 28 of all of the bricks 22 and fills in the “grout lines” between the bricks 22. Once the cement material hardens, the wall 24 is removed from the form 26 and the liner 20 is stripped from the front face of the wall 24 to expose the faces of the brick pavers 22 embedded in the outer surface of the wall 24.

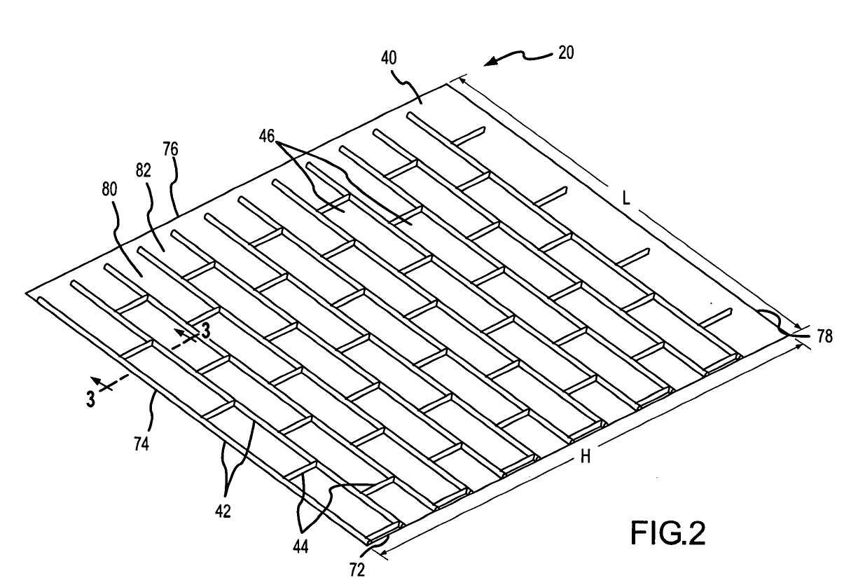

The liner sheet 20 is shown in greater detail in FIG. 2 where it can be seen that the liner preferably comprises a number of foam joints secured to a backing sheet 40. Specifically, the liner sheet 20 includes a plurality of “bed joints” 42 extending horizontally in parallel fashion along a length dimension “L” of the liner 20, as well as a plurality of “head joints” 44 extending vertically between adjacent bed joints 42 to define a plurality of brick-receiving regions 46, as shown in FIG. 2. The joints 42 and 44 are preferably shaped with a convex curve or dome to provide a smooth, concave mortar joint or “grout line” between the embedded brick pavers 22 in the finished wall. However, while the curved or domed shape is preferred, other configurations or shapes of the joints 42 and 44 may also be used within the scope of the present invention.

The head joints 44 extend vertically along a height dimension “H” of the liner sheet 20, and while the embodiment shown in FIG. 2 has a height of twelve bricks, the present invention is not limited to any particular height for the liner sheets 20. Indeed, multiple liners sheets 20 may be vertically stacked within the form 26 to accommodate the formation of tall brick walls, as described in greater detail below. The position of the head joints 44 between the bed joints 42 determines the “bond pattern” for the finished brick wall. In the example shown in FIG. 2, a one-half brick running bond pattern is shown, although other bond patterns (e.g., full, one-quarter, or one-third bond patterns) may be used with the liner of the present invention, as described below. Additionally, the liner of the present invention may be used to form more decorative brick patterns, such as those that include a row of vertical bricks interspersed with the horizontal bricks.

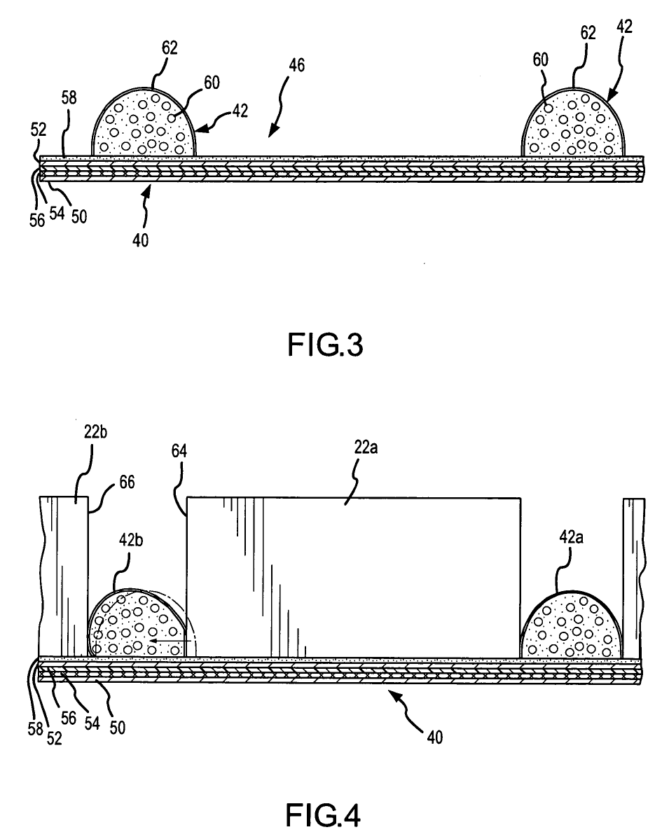

FIG. 3 illustrates an enlarged cross section view of the liner sheet 20 showing the preferred shape and foam material for two adjacent bed joints 42, as well as the preferred laminar construction of the backing sheet 40 used to mount the foam joints 42 and 44 in a desired pattern. In one embodiment, the backing sheet 40 consists of a quad-ply construction having two outer sheets of paper (e.g., a bottom sheet 50 and at a top sheet 52) that sandwich two intermediate plies consisting of a plastic liner 54 and a nylon mesh sheet 56. The outer paper sheets 50 and 52 are preferably formed from commercial (recycled) brown paper that provides a limited amount of protection for the two inner plies as well as a base (on the top sheet 52) for an adhesive material 58, as described below.

The plastic liner 54 is included between the opposing paper sheets 50 and 52 as a waterproofing measure to help protect the paper sheets and prevent water from soaking the entire backing sheet 40 (a distinct possibility considering that the liner sheets 20 will be used at construction sites). Additionally, the nylon mesh sheet 56 is preferably included within the quad-ply construction to promote tear resistance, particularly in the event that one or both of the paper sheets 50 and 52 do become wet. While a nylon mesh is shown in FIG. 3, alternative mesh liners may be used within the scope of the present invention. Indeed, materials other than a mesh may be used to promote tear resistance within the liner sheet 20. Furthermore, alternative embodiments of the backing sheet 40 may forego either the plastic liner 54 or the tear-resistant sheet 56 completely (opting for a triple-ply construction instead) if the remaining layers are proven to be sufficiently tear resistant under wet conditions.

FIG. 3 further illustrates that an adhesive layer 58 is applied to the top sheet 52 of the backing sheet 40. The adhesive layer 58 is preferably a pressure-sensitive, heat-activated adhesive (such as TN-288 Tex Year Industries Hot Melt Pressure Sensitive Adhesive) that is evenly applied over the surface of the top sheet 52 so that the foam joints 42 and 44 may be applied to the top sheet 52 in any desired pattern. Indeed, while the adhesive 58 is preferably sticky or tacky to the touch at room temperature, the adhesive is further activated by a combination of heat and pressure. The adhesive layer 58 thus provides an ideal surface for application of the foam joints 42 and 44 in a below-described process which resembles ironing the foam joints to the top surface 52 of the backing sheet 40.

A preferred construction of the bed joints 42 is illustrated in FIG. 3 where the joints are formed as extruded foam pieces having a rounded or domed cross sectional shape. As noted above, this rounded shape is preferred in order to simulate a more natural grout line between the brick pavers 22 in the finished wall. However, as noted above, alternative shapes for the joints 42 and 44 fall within the scope of the present invention. In particular, the foam joints 42 and 44 are preferably formed from extruded polystyrene and exhibit thermal stability (i.e., no noticeable expansion or contraction) throughout the operational temperature range of the liner sheets 20 (e.g., 0 to 130 degrees Fahrenheit). The cross sectional view of the bed joint 42 in FIG. 3 illustrates an open cell foam core 60 and an outer protective skin 62 that is naturally formed during the foam extrusion process. The outer skin 62 inhibits or prevents the wall material (i.e., concrete) from bonding with the open foam cells 60 during the step of pouring the wall, and thus the extruded foam joints 42 and 44 provide an important benefit over the prior art foam liners described above. Specifically, prior foam liners that were die cut or routed from a solid piece of foam left the open cell foam structure exposed to the liquid cement during the wall pouring process so that the foam joints would be embedded within the finished wall, thus requiring extensive efforts to scrape or otherwise clean the foam from the grout lines between the bricks. The foam joints 42 and 44 of the present invention do not exhibit this problem since the outer skin 62 protects the open foam cells 60 from contacting the concrete slurry during the wall forming process.

A further benefit attributed to the foam joints 42 and 44 of the present invention is that the outer skin 62 is textured in comparison to prior art hard plastic liners, and thus the corresponding grout lines in the finished wall are provided with a more natural “sand” finish as opposed to the smooth grout lines produced by prior art plastic liners. Indeed, the curved, sand-finished foam joints 42 and 44 of the present invention produce highly realistic grout lines in the finished wall that are difficult to distinguish from typical masonry construction.

The present invention also improves over prior art foam and plastic liners by providing increased flexibility for receiving oversized bricks 22, as illustrated in FIG. 4. Specifically, when an oversized brick paver 22a is inserted between two adjacent bed joints 42a and 42b, an edge 64 of the brick paver 22a must be wedged into position on the top surface of the backing sheet 40 by compressing and/or rolling the bed joint 42b. Assuming that another brick paver 22b has already been positioned on the opposite side of the joint 42b, the act of squeezing the brick paver 22a into the brick receiving region 46 (FIG. 3) will tend to compress the joint 42b between the edge 64 of the brick 22a and an edge 66 of the adjacent brick 22b. Additionally, due to both the curved shape of the joints 42 and 44, as well as the overall construction of the liner sheet 20 (i.e., attaching extruded joints to the backing sheet 40 rather than die cutting a solid piece of foam to form the joints), the joint 42b in FIG. 4 may actually be rolled or slightly displaced along the adhesive layer 58 on the top surface of the backing sheet 40. This rolling action is illustrated by the phantom line which shows the original location of the joint 42b before it is compressed and rolled to its final location denoted by the solid line in FIG. 4.

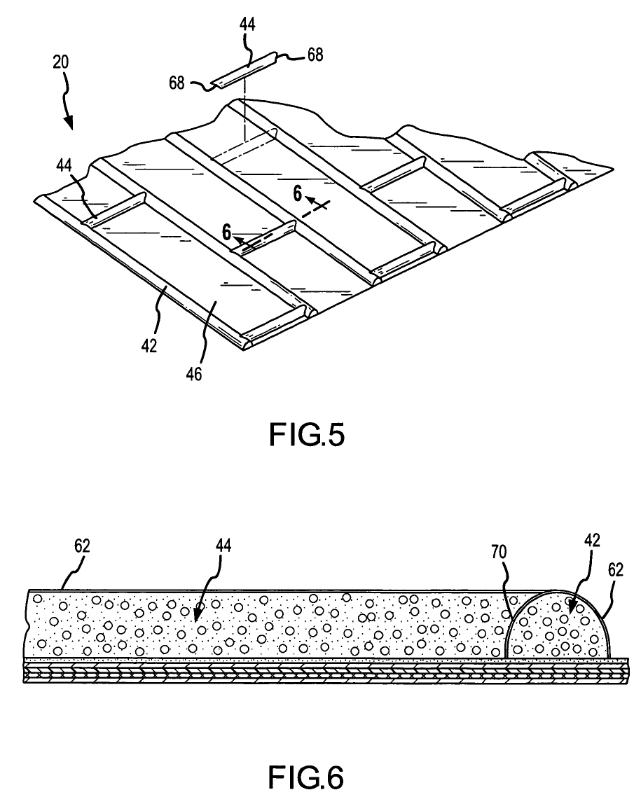

The compressibility of the joints 42 and 44 provides an important benefit over prior plastic liners that were relatively rigid and offered only a limited ability to properly seat an oversized brick paver within the brick receiving region 46. Furthermore, while prior art foam liners provided a slightly higher degree of flexibility to accommodate oversized bricks, the integrated construction of the prior art foam liners (i.e., a grid cut from a solid foam piece) created difficulties for workers attempting to seat the oversized bricks since the square foam joints offered no “rolling” ability and tended to bind at the corners where the bed joints and head joints met. Indeed, as described in the Background section above, prior art foam liners had a tendency to push oversized bricks back out of the brick receiving pocket 46 since forcing one oversized brick into its associated pocket placed increase pressure on all of the adjacent pockets due to the unified construction of the prior foam grids. However, this problem is greatly reduced by the liner sheets 20 of the present invention due to the fact that each of the bed joints 42 and head joints 44 are separately attached to the backing sheet 40. This separate construction is shown in FIG. 5 where a single head joint 44 is shown in an exploded fashion above its normal position (shown in phantom) between two bed joints 42. Each head joint 44 is preferably cut from an extruded foam piece (similar to the bed joints 42), and each end 68 of the head joint 44 is preferably shaped to provide a concave surface 70 (FIG. 6) for mating with the curved outer surface or skin 62 of the bed joint 42. Although the cut ends 68 of the head joint 44 tend to expose the open cell structure of the foam joint 44, FIGS. 5 and 6 illustrate that the ends 68 are shaped in a manner that allow the protective skin 62 on each of the joints 42 and 44 to meet and form a substantial seal against the concrete wall material that is poured into the form 26, as shown in FIG. 1.

Thus, the use of separate bed joints 42 and head joints 44 (i.e., adhering the joints separately to the backing sheet 40 but not to each other) provides a number of benefits over the prior art foam liners that were cut from a single foam piece. While some of these benefits relate to manufacturing cost and ease of use of the finished product (as described below), one important benefit includes an enhanced ability of the joints 42 and 44 to flex and move in response to oversized brick pavers 22. For example, if a brick paver 22 is slightly oversized in its length dimension, at least one end of the paver 22 will tend to compress or roll a head joint 44 to make room for the oversized brick. Because the head joint 44 is not attached to the two adjacent bed joints 42 (as in the prior art), a worker filling the liner 20 with bricks will not meet any significant resistance as the head joint 44 is compressed, nor will the insertion of the oversized brick 22 adversely affect or dislodge any of the pavers 22 positioned above or below the oversized brick 22 in the liner 20. While an adjacent brick receiving pocket 46 may be reduced in size due to the rolling motion of the head joint 44, this discrepancy can be accommodated by slightly compressing the next head joint 44 in the row. Similarly, if a brick paver 22 is oversized in its height dimension (as illustrated in FIG. 4), any compression or rolling of the bed joint 42 is localized to area of the oversized brick 22 and will not be inhibited by the two head joints 44 on either end of the brick 22 since these joints 44 are not attached to the bed joint 42. In sum, any compression or rolling motion experienced by either a bed joint 42 or a head joint 44 due to the insertion of an oversized brick will not place excessive stress on adjacent joints 42 or 44. Thus, the foam liner 20 of the present invention does not exhibit the tendency to bind or force an oversized brick out of the liner pocket 46 as was prevalent with the prior art foam liners that were formed from a single foam block.

Furthermore, while the head joints 44 are precisely mounted on the adhesive backing material 40 to define equally-spaced brick receiving regions 46 (using a below-described preferred process), the separate nature of the head joints 44 makes it is possible for workers to slightly alter the position of the joints 44 in order to accommodate a wall form 26 (FIG. 1) having a length that does not precisely match the bond pattern in the brick. Using the example of the half-brick bond pattern shown in FIGS. 1-7, the foam liner 20 may be unrolled within the construction form 26 only to discover that the liner 20 is an inch too long (i.e., the form 26 is an inch too short to accommodate the full and half-sized bricks that are to be inserted at the end of the liner sheet 20). While one option would be to cut or grind the available bricks to fit within the form, this option is not particularly desirable since such grinding is difficult to do on the construction site and further because the appearance of the finished wall may suffer due to the use of odd-sized bricks at the end of the wall. Fortunately, the head joints 44 of the present invention may be adjusted on the backing sheet 40 in order to meet the available length. For example, the last four head joints 44 on each row of the liner sheet 20 may be moved closer together to reduce the size of their respective brick receiving pockets 46 by ¼ inch each. That is, because the head joints 44 are only adhesively attached to the backing sheet 40, each head joint 44 may be removed and then reattached to the backing sheet 40 at a new location to reduce the size of the brick receiving pocket. Provided that the size reductions are kept to a manageable level (e.g., no more than a quarter of an inch), the foam nature of the head joints will be sufficient to accommodate the smaller brick spacing as described above. In essence, using the above example of adjusting the positions of the final four head joints 44 in each row, these final head joints 44 will be compressed to a greater degree than those for the remainder of the wall 24, thereby resulting in closer spacing and a narrower grout line between the final four bricks in each row of the wall. However, such a small change in spacing is unlikely to be noticed in the final wall and, in any event, is preferable to requiring the use of custom-sized bricks in order to finish the wall.

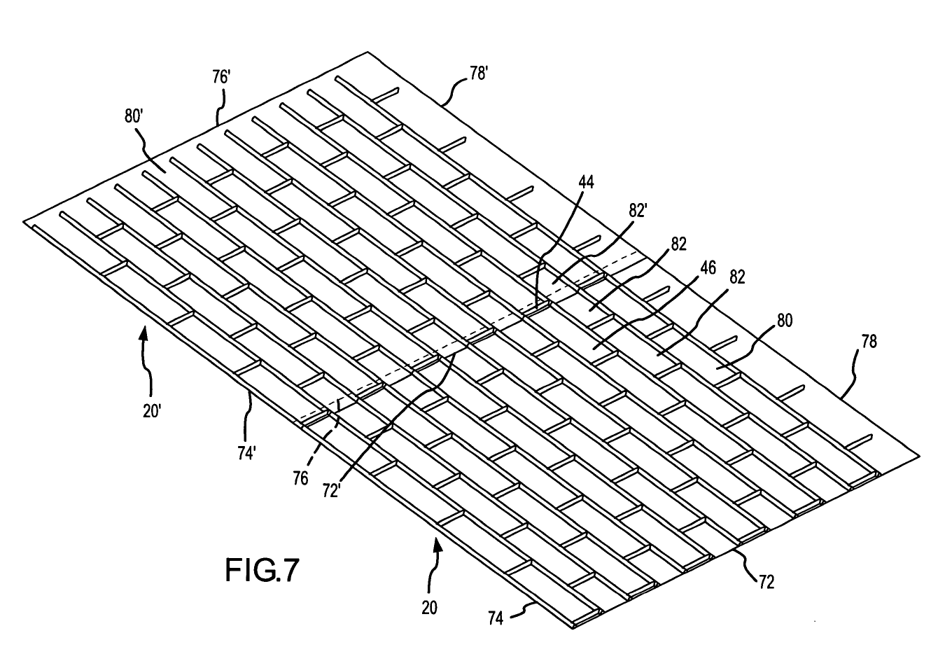

As described above, the liner sheet 20 is preferably formed on a continuous roll of the backing sheet 40 so that prescribed lengths of the liner sheet 20 may be shipped to a job site and unrolled in a form 26 (FIG. 1). However, it will typically be necessary to overlap two or more liner sheets 20 in order to meet the length or height requirements of the form 26. The present invention provides for overlapping the liner sheets 20 by preferably defining finished edges and opposing open edges on each sheet 20, as shown in FIG. 2. In one embodiment, each liner sheet 20 includes a finished side edge 72, a finished bottom edge 74, an open side edge 76, and an open top edge 78, where the side edges 72 and 76 extend along the height dimension of the liner sheet 20 while the bottom and top edges 74 and 78 extend along the length dimension. The finished side edge 72 includes a number of head joints 44 that close off or “finish” the full-sized brick receiving pocket on every other row, while the open side edge 76 does not include any head joints 44 as shown in FIG. 2. Thus, both the side edges 72 and 76 of the liner sheet 20 define half-sized pockets 82 that are open or unbounded by a head joint 44 at one end of the pocket 82. These half-sized pockets 82 are intended to receive half-sized bricks at either end of the finished wall 24 (FIG. 1), but a half-sized pocket 82 on a first liner sheet 20 may be combined with another half-sized pocket 82′ on an overlapping liner sheet 20′, as shown in FIG. 7. Specifically, when a finished edge 72′ of a second liner sheet 20′ overlaps the open edge 76 (shown in phantom in FIG. 7) of the first liner sheet 20, the two half-sized pockets 82 and 82′ are aligned to form a full-sized brick receiving pocket along the seam where the two panels 20 and 20′ overlap. Additionally, the open side edge 76 of the liner sheet 20 further defines a number of full-sized pockets 80 that are open or unbounded by a head joint 44 at the end of the sheet 20, as shown in FIG. 2. When the liner sheet 20 is overlapped by a second liner sheet 20′ as shown in FIG. 7, these full-sized pockets 80 are closed off (to form a full-sized brick receiving region 46) by the corresponding head joints 44 formed along the finished side edge 72′ of the second liner sheet 20′. Thus, the liner sheets 20 and 20′ are easily aligned in the length direction as described above and shown in FIG. 7. Furthermore, while the open top edge 78 of each liner sheet 20 omits a topmost bed joint (as shown in FIG. 2), a second liner sheet (not shown) may be stacked atop the first sheet 20 in the construction form 26 by aligning the finished bottom edge 74 with the open top edge 78 of the first sheet 20 so that the two edges 78 and 74 share the single bed joint 42 along the finished bottom edge 74 of the second liner sheet.

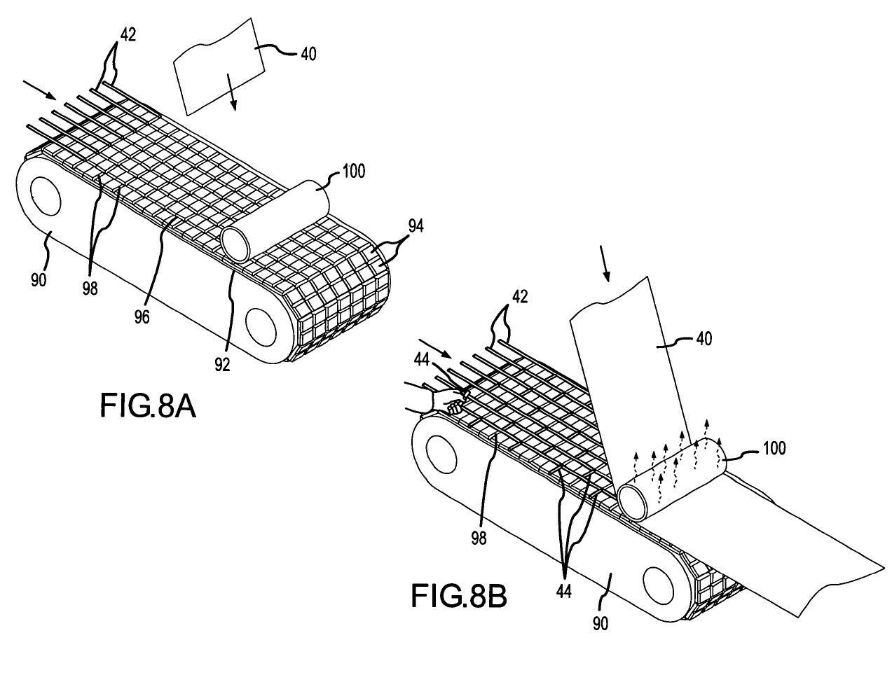

FIGS. 8A and 8B illustrate a preferred method of manufacturing the liner sheets 20 of the present invention. As described above, the bed joints 42 and the head joints 44 are separately attached to the sticky-backed sheet 40 to form a desired bond pattern for the brick pavers 22. In order to ensure that precise spacing is maintained between the joints 42 and 44 in both the horizontal and vertical dimensions, the joints 42 and 44 are preferably laid out on a conveyor belt 90 and then adhered to the backing sheet 40. The use of a conveyor belt 90 allows the liner sheet 20 to be formed in long, continuous rolls which may then be cut to precise lengths required for a specific job site. The ability to form continuous rolls of the foam liner 20 thus provides an important benefit over prior art brick liners that are formed in relatively small rectangular sheets that must be aligned and overlapped along the length of the form 26.

The conveyor belt 90 preferably includes a segmented track 92 made up of a plurality of individual links 94 that together define a series of horizontal bed joint grooves 96 that extend between adjacent rows of the links 94, as well as a series of vertical head joint grooves 98 that extend between adjacent columns of the links. FIG. 8A illustrates that the bed joints 42 are preferably fed into the horizontal grooves 96 at a first end of the conveyor belt 90. The bed joints 42 comprise extruded foam pieces shaped as shown in FIGS. 3 and 4 and are fed into the grooves 96 so that their flat base extends upward to contact the sticky-backed paper 40. Once the bed joints 42 have been seated in their respective grooves 96, the head joints 44 are placed in the appropriate vertical head joint grooves 98 according to the desired running bond pattern. For example, if the individual conveyor tracks 94 each have a length equal to one-half the length of a standard brick paver 22, then the head joints 44 are placed in every other vertical groove 98 along each row of the tracks 94. Furthermore, to form the standard half-brick running bond pattern shown in FIGS. 1-7, the position of the head joints 44 must be staggered for each row as shown in FIG. 8B.

Once the bed joints 42 and head joints 44 have been properly positioned in the grooves 96 and 98, the conveyor belt track 92 is preferably fed beneath a heated roller 100 together with the adhesive backed sheet 40 as shown in FIG. 8B. Specifically, the backing sheet 40 is spooled beneath the roller 100 so that the adhesive layer 58 (FIG. 3) faces downward toward the conveyor track 92 (i.e., the surface of the roller 100 contacts the bottom sheet 50 of the multi-ply backing sheet 40). The roller 100 is positioned at a predetermined distance above the conveyor track 92 so that the backing sheet 40 is pressed down onto the foam joints 42 and 44 with a predetermined force to cause the pressure sensitive adhesive 58 to adhere the joints 42 and 44 to the top sheet 52 of the backing sheet 40. Furthermore, as described above, the adhesive layer 58 is preferably heat-activated and thus the roller 100 is preferably heated in order to increase the temperature of the adhesive and thereby enhance the bond between the adhesive backed sheet 40 and the foam joints 42 and 44.

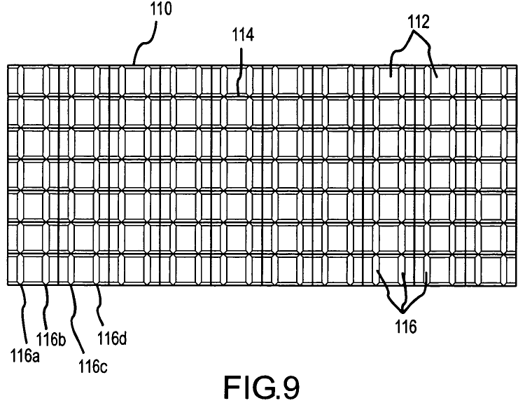

FIG. 9 illustrates an alternative embodiment of the conveyor track 110 having a plurality of tracks 112 that define the horizontal bed joint grooves 114 that are similar to the bed joint grooves 96 shown in FIG. 8A. However, the conveyor track 110 defines an alternative arrangement for the vertical head joint grooves 116 (i.e., two grooves 116 are formed in each of the separate tracks 112), wherein the plurality of grooves 116 may be used to create various different bond patterns in the finished form liner 20. For example, the position of the head joints 44 may be staggered by one groove 116 in each row of the conveyor track 112 to create a one-quarter running bond pattern. That is, a first head joint 114 may be placed in the bottom row of links in FIG. 9 in the left-most column 116a, while a second head joint 114 may be placed in the second row in the second column 116b. Similarly, a third head joint 114 is preferably placed in the third row in column 116c, while a fourth head joint is placed in the fourth row in column 116d. This pattern is then repeated both vertically and horizontally along the track 110 to create the one-quarter running bond pattern. Of course, other bond patterns may be created by altering the position of the head grooves on the conveyor tracks. Alternatively, a “full” bond pattern (where the brick pavers are positioned directly atop one another) may be created using either of the tracks shown in FIGS. 8A and 9 by simply positioning the head joints 44 directly atop one another (i.e., removing the stagger between rows).

In both the embodiments shown in FIGS. 8 and 9, the head joint grooves 98 and 116, respectively, may be color-coded to assist with manual placement of the individual head joints 44 in the appropriate grooves. For example, the head joint grooves 98 in FIG. 8A may be color coded to provide the half-brick running bond pattern shown in FIG. 8B. Alternatively, the head joint grooves 116 in FIG. 9 may have multiple color-coding schemes to provide for different patterns (such as a first scheme to provide a half-brick pattern and a second scheme to provide a quarter-brick pattern). Furthermore, while manual (i.e., hand) placement of the head joints 44 is shown in FIG. 8B, the present invention may be used with an automated placement mechanism (not shown) for the head joints 44.

In summary, the foam brick liner 20 of the present invention is easier to use and provides a more uniform finished wall surface than the prior plastic and foam brick liners described above. Significantly, in light of the ability of the separate foam joints 42 and 44 to accommodate slightly oversized bricks 22, the foam liner 20 may be used with standard brick pavers 22 (as opposed to specialized and costly pavers that have been ground to precise specifications). Furthermore, the foam joints 42 and 44 are separately extruded with a curved or domed shape to closely mimic the grout lines formed by masons, but unlike prior plastic liners providing a similar shape, the malleable foam joints 42 and 44 provide a gasket seal with the bricks 22 to reduce or essentially eliminate concrete seepage to the front face of the brick pavers. Indeed, due to the snug fit provided by the foam joints 42 and 44, the wax coating that must be applied to the bricks used with the prior art plastic liners is no longer needed, thereby further reducing the costs associated use of the foam liner 20. As described in U.S. Pat. No. 5,900,180 (incorporated by reference above), sugar may be used in lieu of wax to retard the curing action of the cement on the front face of the brick pavers 22. Thus, in lieu of applying wax to each brick paver 22 (a costly procedure as described above), a sugar coating may be applied to the liner sheet 20 following the application of the foam joints 42 and 44 to the adhesive backing sheet 40. Specifically, sugar may be used to coat the brick receiving regions 46 on the liner sheet 20 prior to placing the brick pavers 22 within the regions 46. Thus, upon completion of the wall 24 and removal of the liner sheet 20, the sugar coating preferably acts to inhibit the hardening of any concrete material that may have seeped past the foam joints to the front faces of the brick pavers. Specifically, any seepage that may have occurred during the pouring process is easily cleaned from the untreated brick faces by the use of a pressure sprayer or some alternative cleaning process due to the retarding action of the sugar.

Thus, unlike the prior plastic liner sheets described above, the foam liner 20 of the present invention may be used with conventional brick pavers 22 (thereby providing a cost savings over those pavers that require precision grinding and a wax coating). Additionally, the foam liner 20 provides numerous benefits over prior foam liners that were formed from a single foam sheet. Namely, the extruded foam joints 42 and 44 do not bond with the concrete material and thus the foam liner 20 may be easily stripped from the finished wall, as described above. Furthermore, the separate (non-integrated) nature of the bed joints 42 and the head joints 44 provides great flexibility in placement of the head joints, particularly on the job site where slight modification of the head joint location may be required to meet the dimensions of a particular wall form. The foam joints 42 and 44 are also better able to accommodate oversized brick pavers than the prior foam liners where any strain on a single foam joint would be transferred to all the neighboring joints. Lastly, the foam liner 20 may be formed in long, continuous rolls due to the separate application of the extruded bed joints 42 and head joints 44. These rolls may be cut to a precise length as required for a specific job site, or they may simply be cut to length to match the form at the construction site. Thus, while the foam liner 20 includes various finished and open edges to allow for the stacking of multiple sheets 20 (as described above with respect to FIG. 7), the foam liner 20 may be formed in custom lengths or sizes and is thus easier to use than the prior plastic and foam liner sheets that were necessarily formed in rectangular grids (and that required extensive work in order to align and overlap the grids within the form at the construction site).

While a number of presently preferred embodiments of the present invention have been described with a degree of particularity, this description of preferred examples is not intended to limit the scope of the invention. For example, the present invention is not limited to the use of brick pavers 22 as shown in the drawings. Rather, the shape of the “brick” receiving regions 46 could be altered to hold tile, stone or some other common embedded object in place of the brick pavers 22. The scope of the invention is thus defined by the following claims.

The claimed invention is:

1. A liner for casting objects in a face of a poured wall, comprising:
a backing sheet having a length dimension and a height dimension;
a plurality of foam bed joints attached to the backing sheet and extending in a substantially parallel fashion along the length dimension of the backing sheet; and
a plurality of foam head joints attached to the backing sheet and extending along the height dimension of the backing sheet, wherein the foam head joints are formed separately from the foam bed joints, and wherein opposing ends of the foam head joints engage adjacent substantially parallel bed joints to define a plurality of regions on the backing sheet for receiving the objects to be cast in the poured wall.

2. A liner as defined in claim 1 wherein:
the substantially parallel bed joints are spaced a first predetermined distance apart along the height dimension of the backing sheet; and
the head joints are spaced a second predetermined distance apart along the length dimension of the backing sheet.

3. A liner as defined in claim 2 wherein the first and second predetermined distances are substantially equal to the height and length dimensions, respectively, of a brick paver.

4. A liner as defined in claim 1 wherein the bed joints and the head joints each have a substantially semi-circular cross section with a flat base portion attached to the backing sheet and a rounded upper portion adapted to form a rounded grout line between the objects cast in the poured wall.

5. A liner as defined in claim 4 wherein the foam bed joints and the foam head joints each include a protective outer skin to prevent the poured wall from bonding with open foam cells in the joints.

6. A liner as defined in claim 4 wherein the bed joints and the head joints are each formed from extruded polystyrene.

7. A liner as defined in claim 4 wherein:
the backing sheet includes a top surface covered by a pressure-sensitive adhesive coating; and
the flat base portions of the respective bed joints and head joints are pressed against the adhesive coating to secure the foam joints to the top surface of the backing sheet.

8. A liner as defined in claim 7 wherein a sugar coating is applied to the top surface of the backing sheet to retard the setting of any pourable wall material that seeps past the foam joints to a front face of the objects cast in the poured wall.

9. A liner as defined in claim 1 wherein the liner further comprises:
a finished bottom edge having a bed joint extending the length of the liner; and
an open top edge that does not include a bed joint, whereby the finished bottom edge of a second liner is adapted to overlap the open top edge of a first liner to form a combined liner having an extended height dimension.

10. A liner as defined in claim 1 wherein the liner further comprises:
a finished side edge having a plurality of head joints extending along the height dimension of the liner; and
an open side edge that does not include any head joints, whereby the finished side edge of a second liner is adapted to overlap the open side edge of a first liner to form a combined liner having an extended length dimension.

11. A liner for embedding objects in a face of a poured wall, comprising:
a backing sheet;
a plurality of horizontal bed joints attached to a backing sheet, each bed joint comprising an elongated foam piece having a flat base portion adhered to a top surface of the backing sheet and a rounded upper portion extending above the top surface of the backing sheet; and
a plurality of vertical head joints attached to the backing sheet, each head joint comprising a foam piece having a flat base portion adhered to the top surface of the backing sheet and a rounded upper portion extending above the top surface of the backing sheet, and each head joint further defining concave opposing ends adapted to engage the rounded upper portion of an adjacent bed joint, wherein the bed joints and the head joints cooperate to define a plurality of regions on the backing sheet for receiving the objects to be embedded within the poured wall.

12. A liner as defined in claim 11 wherein the backing sheet is formed from multiple layers comprising:
a paper bottom sheet;
a paper top sheet; and
at least one of a plastic liner and a mesh sheet sandwiched between the top and bottom paper sheets.

13. A liner as defined in claim 11, further comprising an adhesive layer applied to the top surface of the backing sheet, wherein the foam bed joints and the foam head joints are positioned on the adhesive layer to form a first predetermined running bond pattern for the embedded objects.

14. A liner as defined in claim 13, wherein a second predetermined running bond pattern is attained by changing the position of the individual head joints on the adhesive layer.

15. A liner as defined in claim 13, wherein the individual head joints are detached and repositioned on the adhesive layer to alter a length dimension of the rectangular regions.

16. A liner as defined in claim 11, wherein compression of a foam head joint by placement of an oversized object within the rectangular region does not place additional stress on an adjacent foam bed joint.

17. A method of forming a liner for embedding a plurality of objects in a face of a poured wall, comprising the steps of:
adhering a plurality of extruded foam bed joints to a top surface of a backing sheet; and
adhering a plurality of extruded foam head joints to the top surface of the backing sheet between adjacent bed joints, wherein the plurality of bed joints and head joints combine to form a plurality of regions for receiving the objects to be embedded within the poured wall.

18. A method as defined in claim 17 further comprising the step of aligning the separate bed joints and head joints to form a grid prior to the steps of adhering the bed joints and the head joints to the top surface of the backing sheet.

19. A method as defined in claim 18 wherein the top surface of the backing sheet is coated with an adhesive layer, and wherein the steps of adhering the bed joints and the head joints to the top surface of the backing sheet further include:
positioning the top surface of the backing sheet over the grid formed by the separate bed joints and head joints; and
applying pressure to a bottom surface of the backing sheet to press the top surface of the backing sheet against the bed joints and head joints and activate the adhesive layer.

20. A method as defined in claim 18 wherein the top surface of the backing sheet is coated with an adhesive layer, and wherein the steps of adhering the bed joints and the head joints to the top surface of the backing sheet further include:
positioning the top surface of the backing sheet over the grid formed by the separate bed joints and head joints; and
simultaneously applying heat and pressure to a bottom surface of the backing sheet to press the top surface of the backing sheet against the bed joints and head joints and activate the adhesive layer.
